(19) United States
(12) Patent Application Publication
(10) Pub. No.: US 2008/0232876 A1
(43) Pub. Date: Sep. 25, 2008

(54) DUPLEX AUTOMATIC SHEET FEEDER

(75) Inventors: Chi-Yao Chen, Miaoli County (TW); Po-Yuan Chang, Tainan City (TW)

Correspondence Address: Muncy, Geissler, Olds & Lowe, PLLC, P.O. BOX 1364, FAIRFAX, VA, 22038-1364, US

(73) Assignee: AVISION INC.

(21) Appl. No.: 12/052,416

(22) Filed: Mar. 20, 2008

(30) Foreign Application Priority Data
Mar. 21, 2007 (TW) 096109648

(51) Int. Cl. G03G 15/00

(52) U.S. Cl. 399/367

(57) ABSTRACT

In a duplex automatic sheet feeder, a passageway group, connected to a supply tray and a discharge tray, includes a plurality of passageways and an image processing region. A sheet detector disposed in the passageway group is for detecting each sheet and thus outputting a sheet detecting signal. A transporting mechanism is for transporting the sheet from the supply tray to the discharge tray through the passageway group. Each sheet is transported across the image processing region at least twice and processed in the image processing region. A control module connected to the transporting mechanism and the sheet detector is for driving the transporting mechanism to transport each sheet, and for making the transporting mechanism switch from a forward-rotating state to a backward-rotating state according to the sheet detecting signal and a predetermined physical quantity so that each sheet is transported by a predetermined distance.

This application claims priority of No. 096109648 filed in Taiwan, R.O.C. on Mar. 21, 2007 under 35 USC 119, the entire content of which are hereby incorporated by reference.

### BACKGROUND OF THE INVENTION

1. Field of Invention

The invention relates to a duplex automatic sheet feeder, and more particularly to a duplex automatic sheet feeder for transporting a sheet in a duplex manner according to a position of a sheet detector and a sheet detecting signal.

1. Related Art

In a conventional duplex scanner, an automatic sheet feeder usually has to turn a sheet (document or original) thrice and transport the sheet through a scanning region thrice when the sheet is being scanned. When the sheet is transported across the scanning region at the first time, a front side of the sheet is scanned. When the sheet is transported across the scanning region at the second time, a backside of the sheet is scanned. When the sheet is transported across the scanning region at the third time, no scanning operation is carried out. The third sheet transporting operation is used for reversing the sheet to keep them in the same order as the original order of the sheets.

Thus, a next sheet cannot be fed until the current sheet is transported across the scanning region at the third time in each scan procedure. A lot of unessential waiting time is wasted so that the scanning operation cannot be carried rapidly in this conventional automatic sheet feeder.

In addition, many branch passageways are formed on the sheet transporting path for turning over the sheet smoothly. In order to make the sheet travel unidirectionally in the branch passageways, an elastic member is disposed at the branching portion. When the elastic member is pushed away by the sheet moving in a first direction, the elastic member guides the sheet, which is moving in a direction opposite to the first direction, to another branch passageway. There are many sheet detectors, which are usually disposed on the passageways in order to judge whether the sheet has left a certain passageway and thus to reverse the direction of the sheet. But the more sheet detectors are disposed, the more cost of the scanner is increased, and the signal processing and controlling methods also become more complicated.

### SUMMARY OF THE INVENTION

It is therefore an object of the invention to provide a duplex automatic sheet feeder effectively transporting a sheet in a duplex manner according to a sheet detecting signal of a sheet detector at a certain position, and the duplex automatic sheet feeder comprises fewer sheet detectors.

In order to achieve the above-identified object, the invention provides a duplex automatic sheet feeder including a supply tray, a discharge tray, a passageway group, a sheet detector, a transporting mechanism and a control module. The supply tray is for storing a sheet before the sheet is transported. The discharge tray is for storing the sheet after the sheet is transported. The passageway group including a plurality of passageways is connected to the supply tray and the discharge tray and has an image processing region. The sheet detector is disposed in the passageway group and for detecting the sheet and outputting a sheet detecting signal. The transporting mechanism is for transporting the sheet from the supply tray to the discharge tray through the passageway group. The sheet is transported across the image processing region at least twice and is processed in the image processing region, and the transporting mechanism has a forward-rotating state and a backward-rotating state. The control module is connected to the transporting mechanism and the sheet detector and for controlling the transporting mechanism to transport the sheet and for making the transporting mechanism switch from the forward-rotating state to the backward-rotating state according to the sheet detecting signal and a predetermined physical quantity. The transporting mechanism transports the sheet by a predetermined distance according to the predetermined physical quantity.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a duplex automatic sheet feeder according to a first embodiment of the invention.

FIG. 2 is a block diagram showing connections between a control module, a sheet detector and a transporting mechanism of FIG. 1.

FIG. 3 is a schematic illustration showing a duplex automatic sheet feeder according to a second embodiment of the invention.

FIG. 4 is a schematic illustration showing a duplex automatic sheet feeder according to a third embodiment of the invention.

### DETAILED DESCRIPTION OF THE INVENTION

The present invention will be apparent from the following detailed description, which proceeds with reference to the accompanying drawings, wherein the same references relate to the same elements.

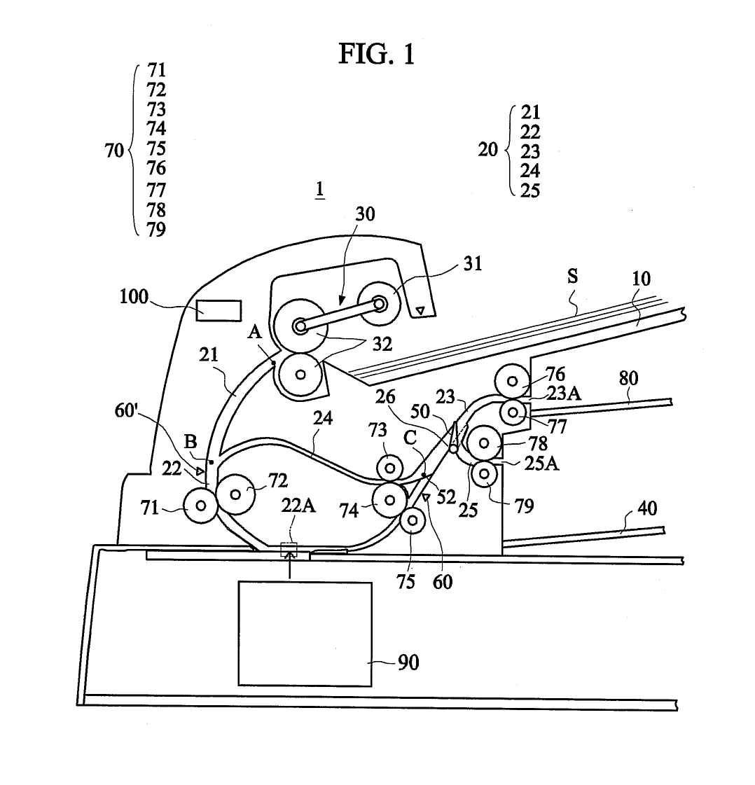

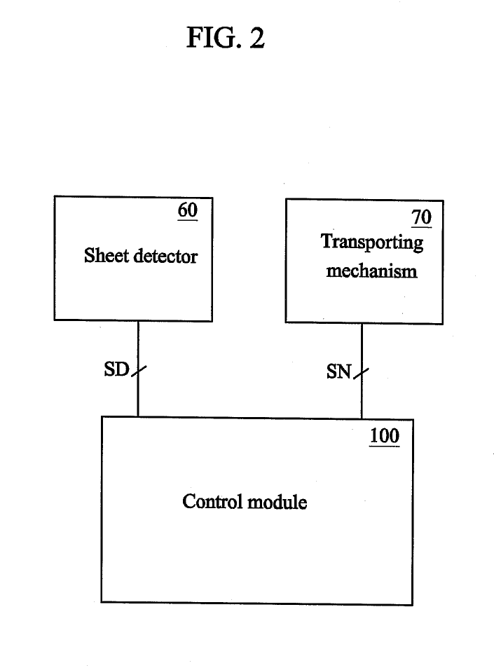

FIG. 1 is a schematic illustration showing a duplex automatic sheet feeder 1 according to a first embodiment of the invention. FIG. 2 is a block diagram showing connections between a control module, a sheet detector and a transporting mechanism of FIG. 1. Referring to FIGS. 1 and 2, the duplex automatic sheet feeder 1 of this embodiment includes a supply tray 10, a passageway group 20, a feeding mechanism 30, a discharge tray 40, a guiding mechanism 50, an elastic guide 52, a sheet detector 60, a transporting mechanism 70, a simplex discharge tray 80 and a control module 100. The passageway group 20 includes a plurality of passageways, such as a first passageway 21 (A to B), a second passageway 22 (B to C), a third passageway 23 (C to 23A), a fourth passageway 24 (C to B) and a fifth passageway 25. The passageway group 20 is connected to the supply tray 10 and the discharge tray 40.

The supply tray 10 stores a plurality of sheets before the sheets are transported. In this embodiment, a topmost sheet S is firstly transported. The discharge tray 40 is for storing the sheets after the sheets are transported. The first passageway 21 is connected to the supply tray 10. The feeding mechanism 30 transports the sheet S to the first passageway 21 from the supply tray 10. In this embodiment, the feeding mechanism 30 includes a pickup roller 31 and a set of separation rollers 32.

The second passageway 22 connected to the first passageway 21 has an image processing region 22A. The sheet detector 60 disposed at the second passageway 22 detects the sheet S transported through the second passageway 22 and outputs a sheet detecting signal SD. In this embodiment, the sheet detector 60 is disposed at the second passageway 22, and in front of a connection portion between the second passageway 22 and the fourth passageway 24 so that the sheet S is firstly transported past the sheet detector 60 and then the connection portion. The sheet detector 60 may be a reflective or transmissive detector and emits an infrared light ray or the like, for example, to detect whether a leading edge or a trailing edge of the sheet has passed by a specific position to serve as a reference for feeding another sheet.

In this embodiment, the image processing region 22A is a scanning region, and a sheet (document or original) moving across this region is scanned by an optical module 90. In another embodiment, the image processing region 22A is a printing region, and a printing module prints data on a sheet moving across this region.

The third passageway 23 is connected to the second passageway 22 so that the sheet can enter the third passageway 23 from the second passageway 22. The fourth passageway 24 has one end connected to the third passageway 23 and the second passageway 22 so that the sheet coming from the third passageway 23 can enter the fourth passageway 24. The fifth passageway 25 is connected to the third passageway 23 so that the sheet coming from the third passageway 23 can enter the fifth passageway 25.

The discharge tray 40 connected to the fifth passageway 25 stores the sheet S after the sheet is scanned. The guiding mechanism 50 is a swingable switching rod disposed at a connection portion 26 between the third passageway 23 and the fifth passageway 25 to selectively guide the sheet S from the third passageway 23 to the fifth passageway 25. Alternatively, the guiding mechanism 50 may be an elastic member, such as Mylar, which will be described later. The elastic guide 52, which may also be regarded as an extension of the guiding mechanism 50, guides the sheet S from the third passageway 23 to the fourth passageway 24, prevents the sheet S coming from the third passageway 23 from entering the second passageway 22, and allows the sheet S to enter the third passageway 23 from the second passageway 22.

The transporting mechanism 70 transports the sheet S from the supply tray 10 to the discharge tray 40 through the passageway group 20. The sheet S is transported across the image processing region 22A at least twice and is processed in the image processing region 22A. The transporting mechanism 70 has a forward-rotating state and a backward-rotating state.

The transporting mechanism 70 includes a plurality of rollers 71 to 79. In a duplex scan mode, to have both sides of the sheet S scanned, the transporting mechanism 70 transports the sheet S from the first passageway 21 to the discharge tray 40 sequentially through the second passageway 22, the third passageway 23, the fourth passageway 24, the second passageway 22, the third passageway 23 and the fifth passageway 25. When the sheet S coming from the second passageway 22 enters the third passageway 23, the elastic guide 52 is slightly pushed away by the sheet S, and the state of the guiding mechanism 50 is shown by the dashed line profile. When the sheet S enters the fourth passageway 24 from the third passageway 23, the state of the guiding mechanism 50 is shown by the dashed line profile, and the elastic guide 52 is in close contact with the connection portion 26. Thus, the elastic guide 52 can guide the sheet S from the third passageway 23 to the fourth passageway 24. When the sheet S enters the fifth passageway 25 from the third passageway 23, the state of the guiding mechanism 50 is shown by the solid line profile.

In this embodiment, the third passageway 23 is also connected to the simplex discharge tray 80. In a simplex scan mode, the transporting mechanism 70 may further transport the sheet S from the first passageway 21 to the simplex discharge tray 80 sequentially through the second passageway 22 and the third passageway 23. An outlet 23A of the third passageway 23 is farther from the discharge tray 40 than an outlet 25A of the fifth passageway 25.

The simplex discharge tray 80 connected to the third passageway 23 stores the sheet S outputted from the third passageway 23 in a simplex mode. In this embodiment, the simplex discharge tray 80 is located at a level higher than the discharge tray 40. Consequently, the user may identify whether the documents or the sheets have been processed in a desired simplex or duplex manner according to the tray in which the documents or the sheets are placed. It is to be noted that the simplex discharge tray 80 may also be omitted.

The control module 100, connected to the transporting mechanism 70 and the sheet detector 60, controls the transporting mechanism 70 to transport the sheet S, and makes the transporting mechanism 70 switch from the forward-rotating state to the backward-rotating state according to the sheet detecting signal SD and a predetermined physical quantity SN. The transporting mechanism 70, equipped with a stepping motor, a DC motor, an AC motor, a brush motor or a brushless motor or the like, transports the sheet S by a predetermined distance according to the predetermined physical quantity SN. For example, the transporting mechanism 70 is frequently equipped with the stepping motor, and the predetermined physical quantity SN is a predetermined number of pulses (or pulse number). Specifically speaking, the sheet detecting signal SD may vary according to the detection of the presence of the sheet S. After the sheet S is firstly transported across the image processing region 22A and the trailing edge of the sheet S passes by the sheet detector 60, the sheet detecting signal SD would vary accordingly to indicate the non-presence of the sheet S. The transporting mechanism 70 starts at the instance when the sheet detecting signal SD varies to transport the sheet S by a predetermined distance according to a predetermined pulse number SN, in order for the trailing edge of the sheet S to move beyond the position of the elastic guide 52. At this time, rotating directions of the rollers 76 and 77 of the transporting mechanism 70 can be reversed so that the sheet S enters the fourth passageway 24 from the third passageway 23, and the sheet can be transported across the image processing region 22A at the second time. It is to be noted that a sheet detector 60′ may work the same function as the sheet detector 60 because the distance between the sheet detector 60 and the elastic guide 52 or between the sheet detector 60′ and the elastic guide 52 is fixed.

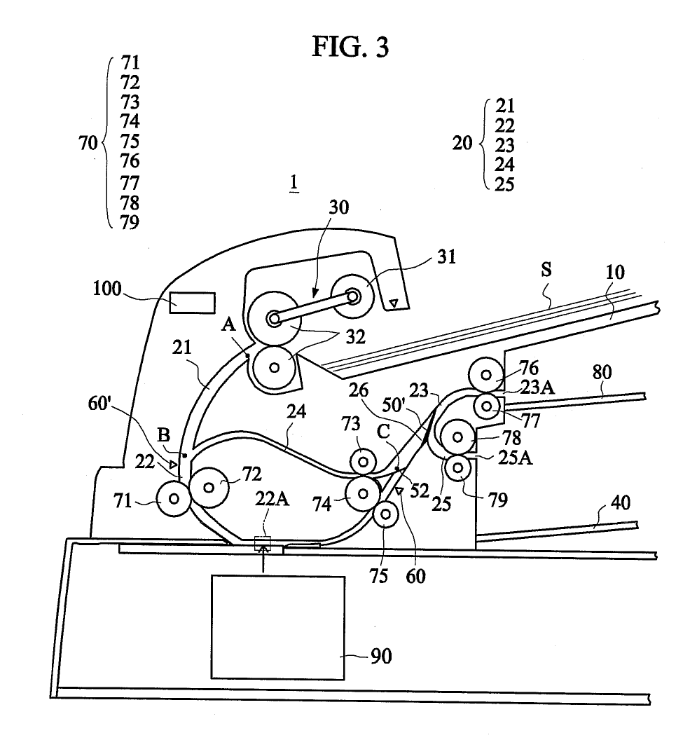

FIG. 3 is a schematic illustration showing a duplex automatic sheet feeder according to a second embodiment of the invention. As shown in FIG. 3, the duplex automatic sheet feeder of this embodiment is similar to the first embodiment except that a guiding mechanism 50′ is an elastic member, such as Mylar. The trailing edge of the sheet S can enter the fourth passageway 24 without passing through the guiding mechanism 50′, so the guiding mechanism 50′ of this embodiment can be used to save the cost and simplify the control method.

It is to be noted that the elastic guide 52 may be replaced with a sub-guiding mechanism (not shown), which is similar to the guiding mechanism 50 and is swingable, for guiding the sheet S from the third passageway 23 to the fourth passageway 24, and for guiding the sheet S from the second passageway 22 to the third passageway 23. Because the sub-guiding mechanism is similar to the guiding mechanism 50 and the position thereof is the same as that of the elastic guide 52, it is not particularly depicted.

In addition, a second sheet can be transported to the first passageway 21 after the second side of the first sheet is scanned and the trailing edge of the first sheet is transported past the point B from the fourth passageway 24 in order to shorten the time of continuously transporting the sheets.

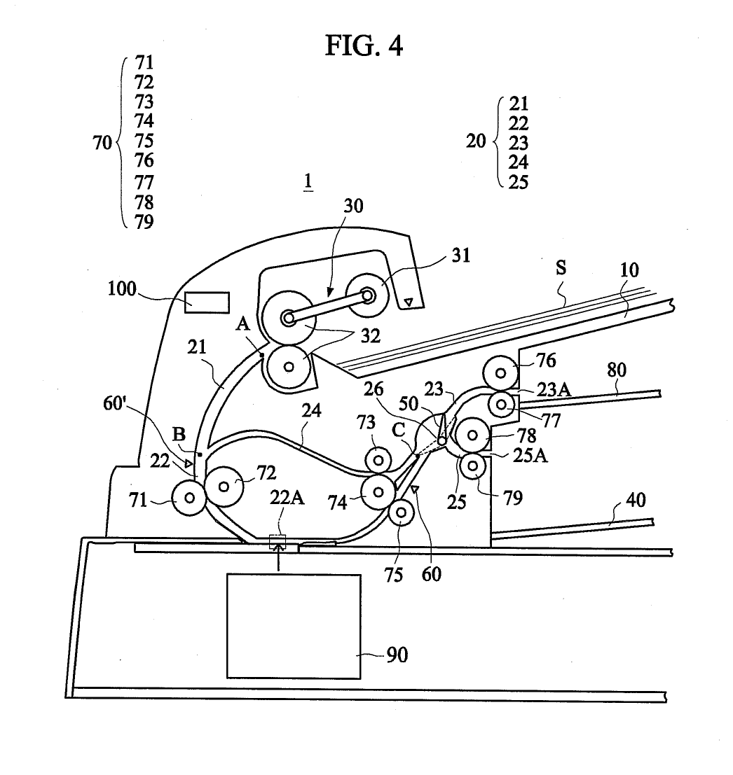

FIG. 4 is a schematic illustration showing a duplex automatic sheet feeder according to a third embodiment of the invention. As shown in FIG. 4, the duplex automatic sheet feeder of this embodiment is similar to the first embodiment except that the elastic guide 52 of the first embodiment is omitted, and the guiding mechanism 50 provides the guiding function of the elastic guide 52 of the first embodiment.

The guiding mechanism 50, disposed at the connection portion 26 between the third passageway 23 and the fifth passageway 25, selectively guides the sheet S from the third passageway 23 to the fifth passageway 25. When the sheet enters the third passageway from the second passageway, the state of the guiding mechanism 50 is shown by the upper dashed line profile. Thus, the guiding mechanism 50 further guides the sheet S from the second passageway 22 to the third passageway 23. When the sheet enters the fourth passageway from the third passageway, the state of the guiding mechanism 50 is shown by the lower dashed line profile. Thus, the guiding mechanism 50 may further guide the sheet S from the third passageway 23 to the fourth passageway 24. When the sheet S enters the fifth passageway from the third passageway, the state of the guiding mechanism 50 is shown by the solid line profile. It is to be noted that the guiding mechanism 50 may only have two states, as indicated by the upper dashed line profile and the solid line profile, and the structure of the passageways can be additionally designed to make the sheet enter the fourth passageway from the third passageway smoothly.

According to the duplex automatic sheet feeder of the invention, the active guiding mechanism is used to guide the travelling direction of the sheet, so the thin sheet is free from the conventional buckling phenomenon. In addition, two discharge trays may be provided so that the user can again identify whether the document or the sheet has been processed in a desired manner. Thus, the convenient and human-oriented advantages can be obtained. In addition, the transporting mechanism can be reversed to transport the sheet from the third passageway to the fourth passageway and transport the sheet across the image processing region at the second time immediately after the sheet has passed through the image processing region at the first time and the trailing edge of the sheet has safely passed through the connection portion between the second passageway and the fourth passageway. Consequently, the time of transporting the sheet can be shortened, and the sheet can be processed quickly.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A duplex automatic sheet feeder, comprising:
a supply tray for storing a sheet before the sheet is transported;
a discharge tray for storing the sheet after the sheet is transported;
a passageway group, which comprises a plurality of passageways, is connected to the supply tray and the discharge tray and has an image processing region;
a sheet detector, disposed in the passageway group, for detecting the sheet and outputting a sheet detecting signal;
a transporting mechanism for transporting the sheet from the supply tray to the discharge tray through the passageway group, wherein the sheet is transported across the image processing region at least twice and is processed in the image processing region, and the transporting mechanism has a forward-rotating state and a backward-rotating state; and
a control module, connected to the transporting mechanism and the sheet detector, for controlling the transporting mechanism to transport the sheet and for making the transporting mechanism switch from the forward-rotating state to the backward-rotating state according to the sheet detecting signal and a predetermined physical quantity, wherein the transporting mechanism transports the sheet by a predetermined distance according to the predetermined physical quantity.

2. The duplex automatic sheet feeder according to claim 1, wherein the passageway group comprises:
a first passageway connected to the supply tray;
a second passageway, which is connected to the first passageway and has the image processing region, wherein the sheet detector is disposed on the second passageway and is for detecting the sheet transported through the second passageway;
a third passageway connected to the second passageway;
a fourth passageway, wherein one end of the fourth passageway is connected to the third passageway and the second passageway; and
a fifth passageway connected to the third passageway and the discharge tray, wherein the transporting mechanism transports the sheet from the first passageway to the discharge tray sequentially through the second passageway, the third passageway, the fourth passageway, the second passageway, the third passageway and the fifth passageway.

3. The duplex automatic sheet feeder according to claim 2, wherein the sheet detector is disposed at the second passageway and in front of a connection portion between the second passageway and the fourth passageway so that the sheet is transported firstly past the sheet detector and then past the connection portion.

4. The duplex automatic sheet feeder according to claim 2, further comprising:
a guiding mechanism, disposed at a connection portion between the third passageway and the fifth passageway, for selectively guiding the sheet from the third passageway to the fifth passageway.

5. The duplex automatic sheet feeder according to claim 4, wherein the guiding mechanism is a swingable switching rod.

6. The duplex automatic sheet feeder according to claim 4, wherein the guiding mechanism is an elastic member.

7. The duplex automatic sheet feeder according to claim 4, wherein the guiding mechanism further guides the sheet from the third passageway to the fourth passageway.

8. The duplex automatic sheet feeder according to claim 4, wherein the guiding mechanism further guides the sheet from the second passageway to the third passageway.

9. The duplex automatic sheet feeder according to claim 2, further comprising:
a feeding mechanism for transporting the sheet to the first passageway from the supply tray.

10. The duplex automatic sheet feeder according to claim 2, wherein the third passageway is connected to the discharge tray, and the transporting mechanism may further transport the sheet from the first passageway to the discharge tray sequentially through the second passageway and the third passageway in a simplex mode.

11. The duplex automatic sheet feeder according to claim 10, wherein an outlet of the third passageway is farther from the discharge tray than an outlet of the fifth passageway.

12. The duplex automatic sheet feeder according to claim 2, further comprising a simplex discharge tray, connected to the third passageway, for storing the sheet discharged from the third passageway in a simplex mode.

13. The duplex automatic sheet feeder according to claim 12, wherein the simplex discharge tray is located at a level higher than the discharge tray.

14. The duplex automatic sheet feeder according to claim 2, further comprising:
an elastic guide for guiding the sheet from the third passageway to the fourth passageway.

15. The duplex automatic sheet feeder according to claim 2, further comprising:
a swingable sub-guiding mechanism for guiding the sheet from the third passageway to the fourth passageway, and for guiding the sheet from the second passageway to the third passageway.
